(19) United States
(12) Patent Application Publication
(10) Pub. No.: US 2006/0125708 A1
(43) Pub. Date: Jun. 15, 2006

(54) Television broadcast receiver

(75) Inventor: Shusuke Narita, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: FUNAI ELECTRIC CO., LTD., Daito-shi (JP)

(21) Appl. No.: 11/288,197

(22) Filed: Nov. 29, 2005

(30) Foreign Application Priority Data
Nov. 29, 2004 (JP) 2004-343439

(51) Int. Cl. H01Q 19/10

(52) U.S. Cl. 343/818; 343/876

(57) ABSTRACT

A TV broadcast receiver connected to a unidirectional antenna Y and a multi-directional antenna S for receiving terrestrial broadcasts comprises: an RF switch connected between a tuner and each of the two antennas Y and S for alternatively switching between the connections to the antennas Y and S; and a controller for determining receiving conditions of receiving TV broadcast signals based on the TV broadcast signals received via the antennas Y and S so as to determine the best one of the antennas Y and S for each channel. Since the controller determines the best one of the antennas Y and S to be used when selecting each channel, and controls the RF switch to switch between the connections to the antennas Y and S, the TV broadcast receiver makes it possible to readily select the best one of the antennas Y and S for each channel.

### BACKGROUND OF THE INVENTION

1. Field of the Invention

The present invention relates to a television broadcast receiver for receiving terrestrial broadcasts.

2. Description of the Related Art

Conventionally, directional antennas such as a Yagi antenna are used to receive terrestrial broadcasts. A directional antenna has a high directivity to be able to receive a weak radio wave or signal. At the same time, the directional antenna has a drawback that it can receive only a radio wave coming from one direction. This is not a big problem in countries like Japan where many broadcast towers are concentrated in one location. However, in countries like the United States of America, this is a big problem as will be explained with reference to FIG. 10 which is a schematic view showing relationships between broadcast towers and directivities of a Yagi antenna Y and a smart antenna S. In such countries, as shown in FIG. 10, there are many areas where broadcast towers A to E spread around cities. If a Yagi antenna Y having a directivity as shown by a range R2 is used in such case, it may occur that the Yagi antenna Y cannot receive many broadcasts from e.g. broadcast towers A to D even if the Yagi antenna is placed close to the broadcast towers A to D.

In order to solve such problem, the EIA (Electronic Industries Association)-909 standard “Antenna Control Interface” was instituted, which provides a technology that a television broadcast receiver can control and change receiving directions of the antenna. More specifically, it is a standard to connect, to a television (TV) broadcast receiver, a so-called smart antenna (designated by S in FIG. 10) which is capable of changing receiving directions, and to control the antenna by the TV broadcast receiver via a modular terminal. In the present specification, the two kinds of antennas are distinguished by referring to the directional antenna, such as the Yagi antenna, as a unidirectional antenna, and by referring to the antenna capable of changing its receiving directions as a multi-directional antenna.

By using such smart antenna S, radio waves from all directions can be received as shown by a range R1. However, the smart antenna S has e.g. a mechanism for changing receiving directions (changing directivity). Accordingly, if the size of the smart antenna S is the same as that of the Yagi antenna Y, it may occur that in a certain receiving direction, the smart antenna S has lower performance than the Yagi antenna Y. This may cause that a radio wave which can be received by the Yagi antenna Y cannot be received by the smart antenna S when the antenna used is switched from the Yagi antenna Y to the smart antenna S (that is, for example, a radio wave transmitted from the broadcast tower E located within the range R2 but outside the range R1 as shown in FIG. 10).

Some technologies are known to select or adjust to a receiving direction of one or multiple antennas. For example, Japanese Laid-open Patent Publication Hei 6-132841 discloses a CS (Communication Satellite) tuner adapted to both a stationary antenna and a rotary antenna by supplying polarization angle adjustment data stored therein to the antenna, depending on the kind of antenna to be used. Further, Japanese Laid-open Patent Publication 2001-320744 discloses a TV broadcast receiver which is capable of adjusting a receiving antenna in a best receiving direction on the basis of an error rate of a received digital television broadcast signal. In addition, Japanese Laid-open Patent Publication He 11-196014 discloses an antenna switching circuit that enables easy switching between multiple antennas.

However, it is not known to connect a unidirectional antenna (Yagi antenna) and a multi-directional antenna (smart antenna) to a TV broadcast receiver in such a that a better one or the best one of the antennas for each channel can be determined on the basis of receiving conditions of TV broadcast signals of the each channel so as to make it possible to select the better or the best one of the antennas when selecting each channel.

### SUMMARY OF THE INVENTION

An object of the present invention is to provide such a TV broadcast receiver for receiving terrestrial broadcasts that is connected to a unidirectional antenna and a multi-directional antenna, and that enables selection of a better or the best one of the antennas for each channel when selecting the each channel.

According to a first aspect of the present invention, the object is achieved by a television broadcast receiver connected to a unidirectional antenna having a single receiving direction and to a multi-directional antenna having multiple receiving directions, the television broadcast receiver comprising: a tuner for selecting a desired channel of television broadcast signals received by either the unidirectional antenna or the multi-directional antenna; a reception control unit for outputting, to the tuner, a channel control signal to command a channel to be selected, and/or for outputting, to the multi-directional antenna, a receiving direction control signal to command a receiving direction for receiving a television broadcast signal, so as to control a reception process of receiving the television broadcast signal; an antenna connection switching unit connected between the tuner and each of the unidirectional antenna and the multi-directional antenna for alternatively making active either the connection of the unidirectional antenna with the tuner or the connection of the multi-directional antennal with the tuner; a first receiving condition determination unit for controlling the antenna connection switching unit to make active the connection of the unidirectional antenna with the tuner, and for determining receiving condition of receiving a television broadcast signal with the unidirectional antenna for the channel selected by the tuner; a second receiving condition determination unit for controlling the antenna connection switching unit to make active the connection of the multi-directional antenna with the tuner, and for determining receiving condition of receiving a television broadcast signal with the multi-directional antenna for the channel selected by the tuner; and a use antenna information determination unit for determining either the unidirectional antenna or the multi-directional antenna as a best antenna for each channel, using the first receiving condition determination unit and the second receiving condition determination unit, and for determining use antenna information, based on which either the unidirectional antenna or the multi-directional antenna to be used for each channel is to be determined.

Therein, based on the use antenna information, the reception control unit determines either the unidirectional antenna or the multi-directional antenna to be used when receiving a television broadcast signal for each channel, and controls the antenna connection switching unit to make active the connection of the tuner with the determined one of the unidirectional antenna and the multi-directional antenna to be used, and further outputs the channel control signal and/or the receiving direction control signal so as to control the reception process of receiving the television broadcast signal.

The television broadcast receiver according to the first aspect of the present invention determines the best one of the unidirectional antenna and the multi-directional antenna, to be used for each channel, on the basis of the receiving conditions of the television broadcast signals both with the unidirectional antenna and with the multi-directional antenna so as to determine the use antenna information, based on which either the unidirectional antenna or the multi-directional antenna to be used for each channel is to be determined. Based on the use antenna information, the television broadcast receiver determines either the unidirectional antenna or the multi-directional antenna to be used when receiving a television broadcast signal for each channel, and controls the antenna connection switching unit to make active the connection of the tuner with the determined one of the unidirectional antenna and the multi-directional antenna to be used. Accordingly, the television broadcast receiver makes it possible to readily select the best one of the unidirectional antenna and the multi-directional antenna for each channel.

Preferably, the television broadcast receiver further comprises a use antenna information storage unit for storing the use antenna information determined by the use antenna information determination unit. The television broadcast receiver according to the preferred mode is advantageous in that as to a channel for which use antenna information is already stored, the television broadcast receiver is not required to determine use antenna information again at the time of selecting the channel, and makes it possible to immediately receive a television broadcast signal of the selected channel by using the best one of the two antennas.

According to a second aspect of the present invention, the above-described object is achieved by a television broadcast receiver connected to a unidirectional antenna having a single receiving direction and to a multi-directional antenna having multiple receiving directions, the television broadcast receiver comprising: a tuner for selecting a desired channel of television broadcast signals received by either the unidirectional antenna or the multi-directional antenna; a reception control unit for outputting, to the tuner, a channel control signal to command a channel to be selected, and/or for outputting, to the multi-directional antenna, a receiving direction control signal to command a receiving direction for receiving a television broadcast signal, so as to control a reception process of receiving the television broadcast signal; a best receiving direction finding unit for finding a best receiving direction for each channel selected by the tuner from the multiple receiving directions of the multi-directional antenna when receiving a television broadcast signal with the multi-directional antenna for the each channel; an antenna connection switching unit connected between the tuner and each of the unidirectional antenna and the multi-directional antenna for alternatively making active either the connection of the unidirectional antenna with the tuner or the connection of the multi-directional antennal with the tuner; a first receiving condition determination unit for controlling the antenna connection switching unit to make active the connection of the unidirectional antenna with the tuner, and for determining receiving condition of receiving a television broadcast signal, with the unidirectional antenna for the channel selected by the tuner, on the basis of BER values of the received television broadcast signal; a second receiving condition determination unit for controlling the antenna connection switching unit to make active the connection of the multi-directional antenna with the tuner, and for determining receiving condition of receiving a television broadcast signal, in a best receiving direction with the multi-directional antenna for the channel selected by the tuner, on the basis of BER values of the received television broadcast signal; a use antenna information determination unit for determining either the unidirectional antenna or the multi-directional antenna to give the lower BER value for each channel, using the first receiving condition determination unit and the second receiving condition determination unit, and for determining use antenna information, based on which either the unidirectional antenna or the multi-directional antenna to be used for each channel is to be determined; and a use antenna information storage unit for storing the use antenna information determined by the use antenna information determination unit.

Therein, based on the use antenna information, the reception control unit determines either the unidirectional antenna or the multi-directional antenna to be used when receiving a television broadcast signal for each channel, and controls the antenna connection switching unit to make active the connection of the tuner with the determined one of the unidirectional antenna and the multi-directional antenna to be used, and further outputs the channel control signal and/or the receiving direction control signal so as to control the reception process of receiving the television broadcast signal.

Similarly as in the first aspect of the present invention, the television broadcast receiver according to the second aspect of the present invention determines the best one of the unidirectional antenna and the multi-directional antenna, to be used for each channel, on the basis of the receiving conditions of the television broadcast signals both with the unidirectional antenna and with the multi-directional antenna so as to determine the use antenna information, based on which either the unidirectional antenna or the multi-directional antenna to be used for each channel is to be determined. Based on the use antenna information, the television broadcast receiver determines either the unidirectional antenna or the multi-directional antenna to be used when receiving a television broadcast signal for each channel, and controls the antenna connection switching unit to make active the connection of the tuner with the determined one of the unidirectional antenna and the multi-directional antenna to be used. Accordingly, the television broadcast receiver makes it possible to readily select the best one of the unidirectional antenna and the multi-directional antenna for each channel.

Furthermore, in the television broadcast receiver of the second aspect of the present invention, the best receiving direction finding unit is provided to find a best receiving direction for each channel selected by the tuner from the multiple receiving directions of the multi-directional antenna when receiving a television broadcast signal with the multi-directional antenna for the each channel. Accordingly, when receiving a television broadcast signal with the multi-directional antenna, the television broadcast signal can be received under the best receiving condition.

In addition, the television broadcast receiver according to the second aspect of the present invention comprises a use antenna information storage unit for storing the use antenna information determined by the use antenna information determination unit. Accordingly, as to a channel for which use antenna information is already stored, the television broadcast receiver is not required to determine use antenna information again at the time of selecting the channel, and makes it possible to immediately receive a television broadcast signal of the selected channel by using the best one of the two antennas.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic block diagram showing a TV broadcast receiver according to an embodiment of the present invention;

FIG. 2 is a schematic view of a use antenna information table stored in a memory of the TV broadcast receiver;

FIG. 3 is a chart showing and explaining multiple receiving directions of a smart antenna connected to the TV broadcast receiver;

FIG. 4 and FIG. 5 are flow charts showing an omni-directional scanning process performed by the TV broadcast receiver;

FIG. 6 is a flow chart showing a best receiving direction finding process performed by the TV broadcast receiver;

FIG. 7 is a flow chart showing a channel selection process performed by the TV broadcast receiver;

FIG. 8 is a flow chart showing a video reception process performed by the TV broadcast receiver;

FIG. 9 is a flow chart showing a no signal process performed by the TV broadcast receiver; and

FIG. 10 is a schematic view showing relationships between broadcast towers and directivities of a Yagi antenna and a smart antenna.

### DESCRIPTION OF THE PREFERRED EMBODIMENTS

The best modes and preferred embodiments of the present invention will be described hereinafter with reference to the annexed drawings. Note that the specific embodiments described are not intended to cover the entire scope of the present invention, and hence the present invention is not limited to only the specific embodiments.

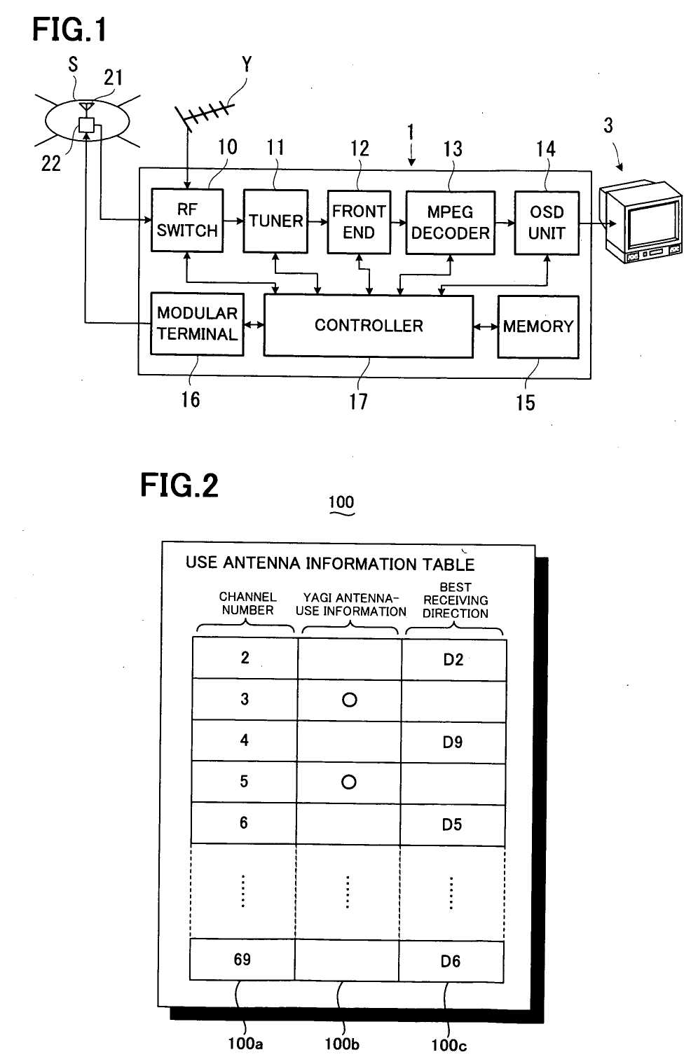

FIG. 1 is a schematic block diagram showing a television (TV) broadcast receiver 1 according to an embodiment of the present invention. Referring to FIG. 1, the TV broadcast receiver 1 is connected to a Yagi antenna (unidirectional antenna having a single receiving direction) Y and a smart antenna (multi-directional antenna having multiple receiving directions) S, and receives each digital TV broadcast signal (hereafter referred to simply as “TV broadcast signal”) transmitted in a given frequency band from each broadcast station (broadcast tower) so as to output a television program contained in the TV broadcast signal of each channel to a monitor 3. Note that in the present embodiment, a physical channel that is a frequency band of carrier wave used for broadcast of a TV program is referred to simply as “channel”.

The TV broadcast receiver 1 comprises: an RF (Radio Frequency) switch 10; a tuner 11; a front end 12 for subjecting the TV broadcast signal received by the tuner 11 to predetermined signal processing so as to decode the received TV broadcast signal; an MPEG (Motion Picture Experts Group) decoder 13 for decoding the TV broadcast signal which is an MPEG-compressed signal; an on-screen display (OSD) unit 14 for superimposing a signal of a predetermined display image on the decoded TV broadcast signal to produce a combined signal and outputting the combined signal to the monitor 3; a memory 15 for storing various information; a modular terminal 16 connected to an antenna controller 22; and a controller 17 for controlling the entire TV broadcast receiver 1. The smart antenna S comprises an antenna unit 21 and the antenna controller 22.

The RF switch 10 is connected between the tuner 11 and each of the two kinds of antennas S and Y, and alternatively makes active either the connection of the Yagi antenna Y with the tuner 11 or the connection of the smart antenna S with the tuner 11 under the control of the controller 17, namely alternatively switches between the antenna connections. By performing the antenna connection switching, the RF switch 10 serves as an antenna connection switching unit. The tuner 11 selects a desired channel from TV broadcast signals received by either one of the two antennas S and Y.

The front end 12 subjects a TV broadcast signal of a channel selected by the tuner 11 to error correction, and separates a video stream containing necessary TS (Transport Stream) packets from a multiplexed signal, and further supplies necessary TS packets to respective blocks and units in the TV broadcast receiver 1. The BER (Bit Error Rate) of the received TV broadcast signal is detected by the front end 12. The MPEG decoder 13 decodes the video stream separated by the front end 12 into a video signal, and outputs the thus obtained video signal to the monitor 3 via the OSD unit 14.

The memory 15 stores various information including a use antenna information table 100, as shown in FIG. 2, created by e.g. a later described omni-directional scanning process. Referring to FIG. 2, the use antenna information table 100 has information including: channel numbers 100a of respective channels transmitted from respective broadcast stations; Yagi antenna-use information 100b to indicate whether or not to use the Yagi antenna Y for receiving the respective channels; and best receiving directions 100c to use the smart antenna S for receiving the respective channels. Note that in the Yagi antenna-use information 100b in FIG. 2, a mark “◯” therein indicates the use of the Yagi antenna Y to receive the respective channels, while a black space indicates the non-use of the Yagi antenna Y (in which case the smart antenna S is inevitably used). In the present specification, the information indicated by the use antenna information table 100 is referred to as use antenna information, indicating which antenna is to be used, either the Yagi antenna Y or the smart antenna S, and which is the best receiving direction in the case of using the smart antenna S.

Based on the use antenna information table 100, the controller 17 determines either the antenna S or the antenna Y to be used for receiving a TV broadcast signal of each channel, and controls the RF switch 10 to make active one of the connections of the tuner 11 with the antennas S and Y, namely to switch between the connection of the tuner 11 with one of the antennas S and Y and the connection of the tuner 11 with the other of the antennas S and Y The controller 17 outputs, to the tuner 11, a channel control signal for commanding a channel to be selected, and also outputs, to the antenna controller 22 of the smart antenna S, a receiving direction control signal for commanding a receiving direction to receive a TV broadcast signal, whereby the controller 17 controls a receiving operation for receiving a TV broadcast signal. By performing the receiving operation control, the controller 17 serves as a reception control unit.

Furthermore, as will be apparent from the description below, the controller 17 with related units and elements serves as a best receiving direction finding unit by performing a best receiving direction finding process. In addition, as will be further apparent from later descriptions, by performing an omni-directional scanning process including the best receiving direction finding process, the controller 17 with related units and elements also serves as a first receiving condition determination unit for determining the receiving condition with the Yagi antenna Y, a second receiving condition determination unit for determining the receiving condition with the smart antenna S, and a use antenna information determination unit for determining the information as to the antenna to be used.

Briefly describing these determination units here, firstly the first receiving condition determination unit is provided for controlling the antenna connection switching unit (RF switch 10 with controller 17) to make active the connection of the Yagi antenna Y with the tuner 11, and for determining receiving condition of receiving a television broadcast signal with the Yagi antenna Y for the channel selected by the tuner 11. More specifically, the first receiving condition determination unit determines receiving condition of receiving the television broadcast signal, with the Yagi antenna Y for the channel selected by the tuner 11, on the basis of BER values of the received television broadcast signal.

The second receiving condition determination unit is provided for controlling the antenna connection switching unit to make active the connection of the smart antenna S with the tuner 11, and for determining receiving condition of receiving a television broadcast signal with the smart antenna S for the channel selected by the tuner 11. More specifically, the second receiving condition determination unit determines receiving condition of receiving a television broadcast signal, in a best receiving direction with the smart antenna S for the channel selected by the tuner 11, on the basis of BER values of the received television broadcast signal.

Further, the use antenna information determination unit is provided for determining either the Yagi antenna Y or the smart antenna S as a best antenna for each channel, using the first receiving condition determination unit and the second receiving condition determination unit, and for determining use antenna information, based on which either the Yagi antenna Y or the smart antenna S to be used for each channel is to be determined. The use antenna information, more specifically, is the information indicated by the use antenna information table 100, indicating which antenna is to be used, either the Yagi antenna Y or the smart antenna S, and which is the best receiving direction in the case of using the smart antenna S.

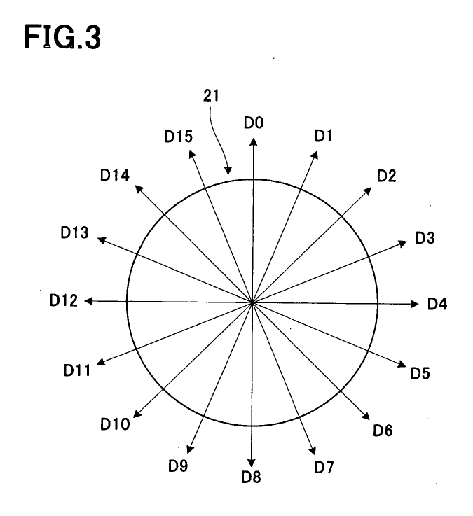

FIG. 3 is a chart showing and explaining multiple receiving directions of the smart antenna S. When connected to the smart antenna S, the TV broadcast receiver 1 according to the present embodiment receives, and measures receiving conditions of, TV broadcast signals coming from sixteen receiving directions provided in the EIA-909 standard as indicated by D0 to D15 in FIG. 3, respectively. The smart antenna S comprises: an antenna unit 21 for receiving TV broadcast signals from the sixteen receiving directions D0 to D15 by mechanically or electronically switching an active receiving direction (namely, making one of the multiple receiving directions active); and an antenna controller 22 for controlling the operation of the antenna unit 21. Based on the receiving direction control signal from the TV broadcast receiver 1, the antenna controller 22 makes active one of the multiple receiving directions D0 to D15 of the antenna unit 21 which is commanded by the control signal.

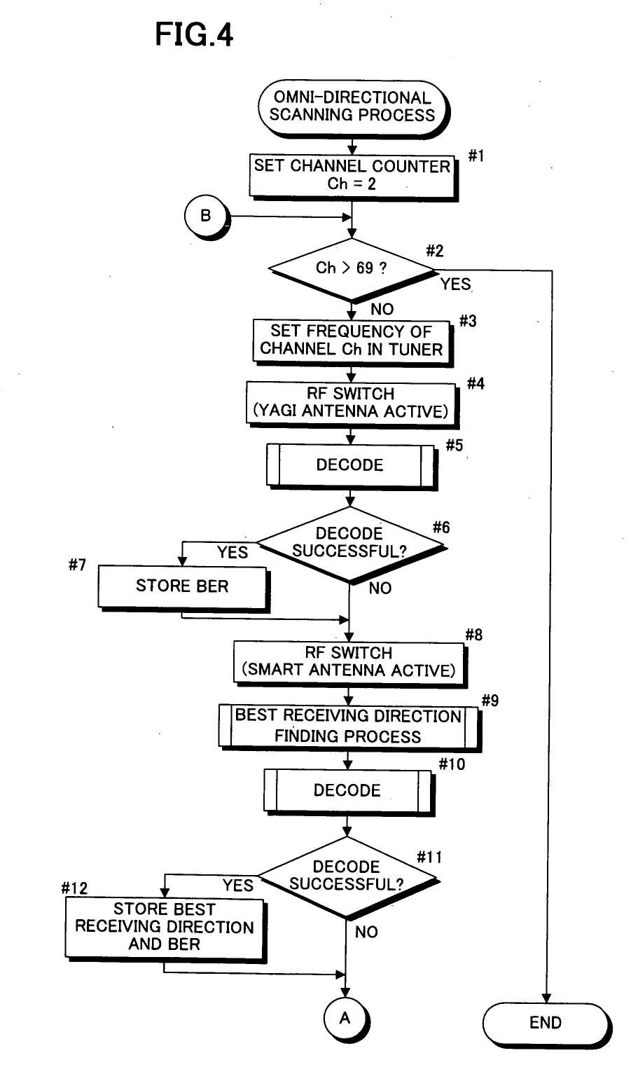

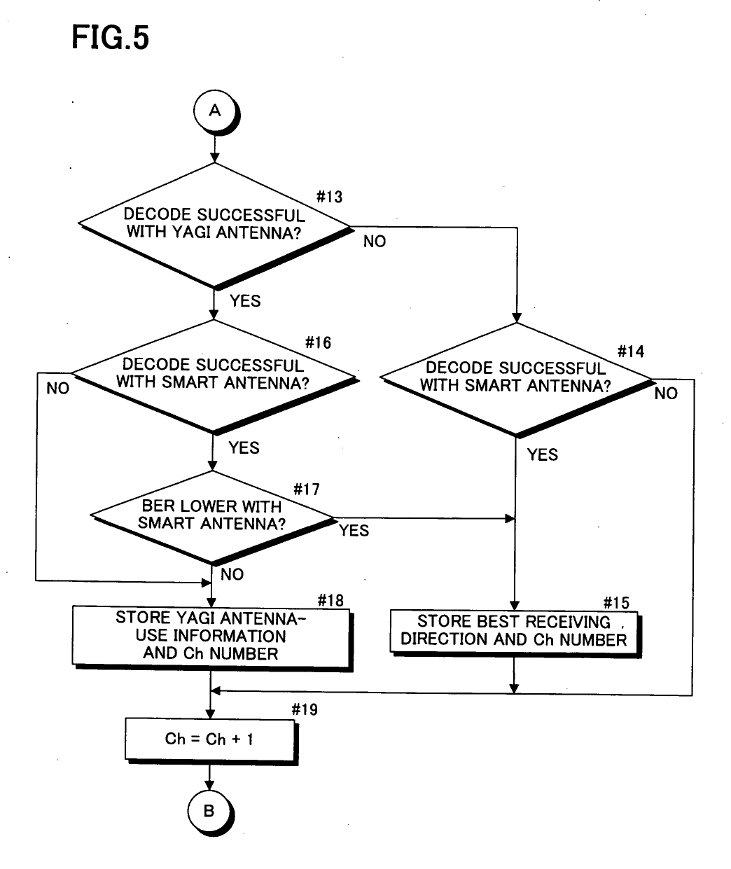

Referring now to the flow charts of FIG. 4 and FIG. 5, an omni-directional scanning process performed by the TV broadcast receiver 1 will be described. As apparent from the description below, the omni-directional scanning process is a process to sequentially measure receiving conditions of a multi-directional antenna (smart antenna S) for receiving a TV broadcast signal of a selected channel in all the receiving directions of the multi-directional antenna, and to automatically determine a receiving direction which enables TV broadcast signal reception in a best receiving condition for the channel. When the omni-directional scanning process is started, the controller 17 sets a value of a channel Ch (#1) (more specifically sets a counter at 2 for channel 2), and repeats a process of steps #3 to #19 for each of channels 2 to 69. More specifically, the controller 17 sets a frequency of a channel Ch in the tuner 11 (#3), and at the same time controls the RF switch 10 to make active the connection between the RF switch 10 and the Yagi antenna Y (#4). The controller 17 further commands the MPEG decoder 13 to decode a TV broadcast signal selected and received by the tuner (#5), and further determines whether or not the MPEG decoder 13 has succeeded in decoding the TV broadcast signal (#6).

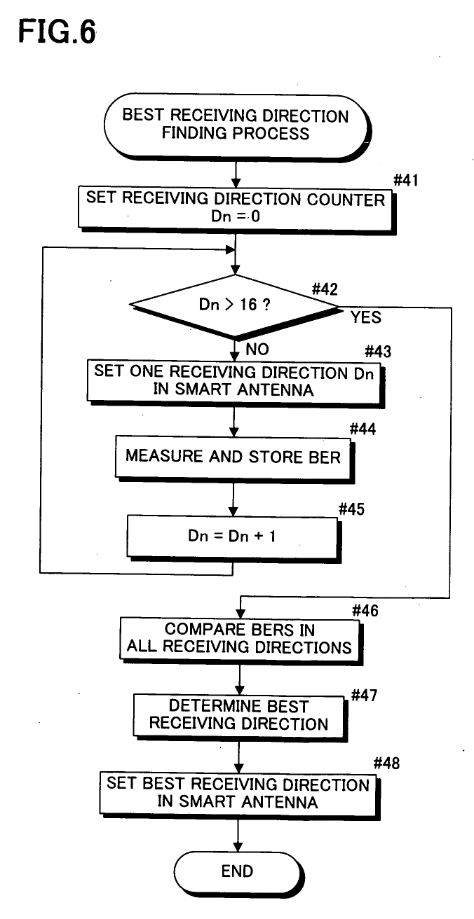

If the decoding is successful (YES in #6), the controller 17 stores the BER value of the received TV broadcast signal in the memory 15 (#7), and controls the RF switch 10 to make active the connection between the RF switch 10 and the smart antenna S (#8). On the other hand, if the decoding is unsuccessful (NO in #6), the controller 17 controls the RF switch 10 to make active the connection between the RF switch 10 and the smart antenna S without storing the BER value in the memory 15 (#8). Subsequently, the controller 17 controls to perform a best receiving direction finding process in a step #9 for the selected channel which will be more specifically shown in the flow chart of FIG. 6 as described below.

Referring to FIG. 6, when the best receiving direction finding process is started, the controller 17 first sets a value of a receiving direction Dn at zero (more specifically sets a counter at zero for receiving direction Dn) (#41), and then determines whether or not the value of the receiving direction Dn is larger than 16 (#42). The controller 17 repeats a process of steps #43 to #45 for each of all the receiving directions Dn for the selected channel. More specifically, the controller 17 first outputs a receiving direction control signal to the antenna controller 22 via the modular terminal 16 so as to set one receiving direction Dn as an active receiving direction in the smart antenna S (#43). The controller 17 then measures the BER value of the received TV broadcast signal in the selected channel in this receiving direction Dn, and stores the thus measured BER value in the memory 15 (#44).

Subsequently, the controller 17 increments the value (counter) of the receiving direction Dn (#45) so as to perform the steps #42 to #44 for the receiving direction with the incremented value Dn+1. After repeating the steps #43 to #45 for each of all the receiving directions Dn so as to complete measurements of the BER values in all the receiving directions Dn (YES in #42), the controller 17 compares the BER values of the received TV broadcast signals of the selected channel in all the receiving directions (#46) so as to determine the receiving direction giving the lowest BER value as a best receiving direction 100c for the selected channel (#47). Thereafter, the controller 17 outputs, to the antenna controller 22 via the modular terminal 16, a receiving direction control signal to command the thus determined best receiving direction 100c so as to set the thus determined best receiving direction 100c to be the active receiving direction in the smart antenna S for the selected channel (#48).

Referring back to the flow chart of FIG. 4, the omni-directional scanning process, after the best receiving direction finding process in the step #9, will be described. After the controller 17 sets the best receiving direction 100c of the smart antenna S for the selected channel in the above described manner by the best receiving direction finding process (#9), the controller 17 commands the MPEG decoder 13 to decode the received TV broadcast signal, and further determines whether or not the MPEG decoder 13 has succeeded in decoding the TV broadcast signal (#11). If the decoding is successful (YES in #11), the controller 17 stores both the BER value of the received TV broadcast signal and the best receiving direction 100c for the selected channel in the memory 15 (#12). On the other hand, if the decoding is unsuccessful (NO in #11), the omni-directional scanning process goes to a step #13 as shown in FIG. 5 without storing the BER value in the memory 15.

Referring to FIG. 5, the controller 17 determines whether or not the MPEG decoder 13 has succeeded in decoding the TV broadcast signal of the selected channel received by the Yagi antenna Y (namely determines whether or not the controller 17 has stored the BER value of the TV broadcast signal in the memory 15 in the step #7) (#13). If the decoding is unsuccessful (NO in #13), the controller 17 further determines whether or not the MPEG decoder 13 has succeeded in decoding the TV broadcast signal of the selected channel received by the smart antenna S (namely determines whether or not the controller 17 has stored the BER value of the TV broadcast signal and the best receiving direction for the selected channel in the memory 15 in the step #12) (#14).

If the decoding is unsuccessful with both the Yagi antenna Y and the smart antenna S (NO in #13 and NO in #14), the controller 17 increments the value (counter) of the channel Ch (#19) so as to perform the preceding steps, namely the steps #2 to #19, of the omni-directional scanning process for a new channel with the incremented value (Ch+1). On the other hand, if the decoding is successful with the smart antenna S in the step #14 (YES in #14), the controller 17 stores the best receiving direction 100c for the selected channel in the memory 15 by associating the best receiving direction 100c with the channel number 100a (value of Ch) of the selected channel (#15). Thereafter, the controller 17 increments the value (counter) of the channel Ch (#19) so as to perform the preceding steps, namely the steps #2 to #19, of the omni-directional scanning process for a new channel with the incremented value (Ch+1).

If the controller 17 determines that the decoding is successful with the Yagi antenna Y (YES in #13), the controller 17 further determines whether or not the decoding is successful with the smart antenna S (#16). If the decoding is unsuccessful with the smart antenna S (NO in #16), the controller 17 stores the Yagi antenna-use information 100b for the selected channel in the memory 15 by associating the Yagi antenna-use information 100b with the channel number 100a (value of Ch) of the selected channel (#18). Thereafter, the controller 17 increments the value (counter) of the channel Ch (#19) so as to perform the preceding steps, namely the steps #2 to #19, of the omni-directional scanning process for a new channel with the incremented value (Ch+1).

On the other hand, if the decoding is successful with the smart antenna S (YES in #16), the controller 17 compares the BER values stored in the steps #7 and #12 so as to determine whether or not the BER value with the smart antenna S is lower than that with the Yagi antenna Y (#17). If the BER value with the smart antenna S is lower than the BER value with the Yagi antenna Y (YES in #17), the controller 17 stores the best receiving direction 100c for the selected channel in the memory 15 by associating the best receiving direction 100c with the channel number 100a (value of Ch) of the selected channel (#15). Thereafter, the controller 17 increments the value (counter) of the channel Ch (#19) so as to perform the preceding steps, namely the steps #2 to #19, of the omni-directional scanning process for a new channel with the incremented value (Ch+1).

If, on the other hand, the BER value with the smart antenna S is equal to or higher than the BER value with the Yagi antenna Y (NO in #17), the controller 17 stores the Yagi antenna-use information 100b for the selected channel in the memory 15 by associating the Yagi antenna-use information 100b with the channel number 100a (value of Ch) of the selected channel (#18). Thereafter, the controller 17 increments the value (counter) of the channel Ch (#19) so as to perform the preceding steps, namely the steps #2 to #19, of the omni-directional scanning process for a new channel with the incremented value (Ch+1).

If the controller 17 completes the steps #3 to #19 for all the channels (YES in #2), the controller 17 ends the omni-directional scanning process, and creates a use antenna information table 100 as shown in FIG. 2. In this way, according to the present embodiment, the controller 17 determines receiving conditions of, and processes, received TV broadcast signals on the basis of BER values of the TV broadcast signals. It is to be noted here that the use antenna information table 100 itself or the combination of the controller 17 with related units and elements including the memory 15 for creating and storing the use antenna information table 100 serves as a use antenna information storage unit for storing the use antenna information including the Yagi antenna-use information 100b and/or the best receiving directions 100c.

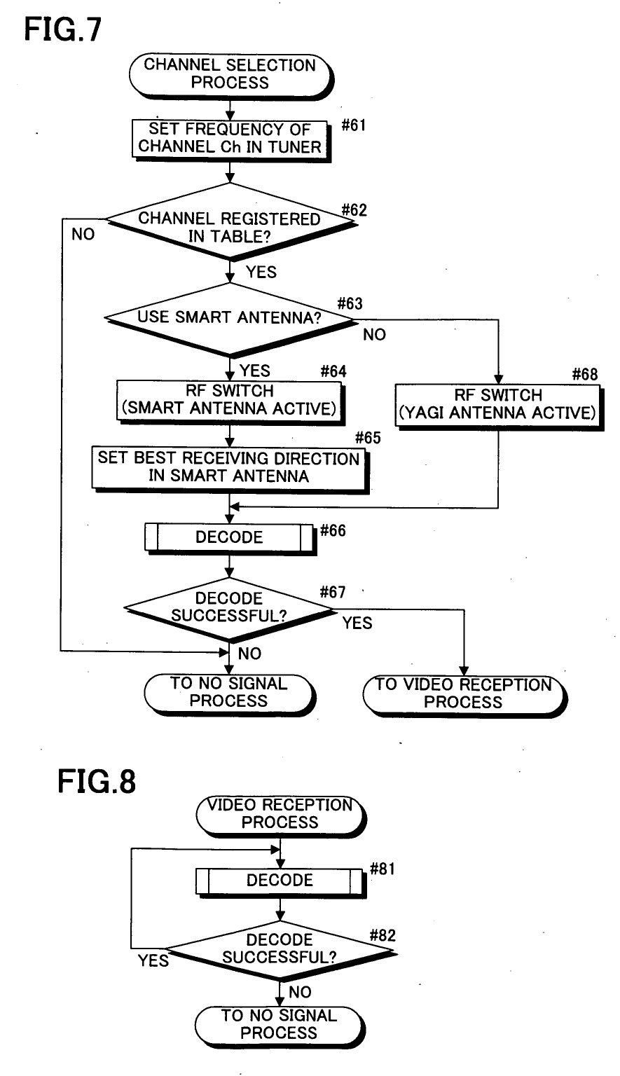

Referring now to the flow chart of FIG. 7, a channel selection process will be described. For example, when a user selects a channel to view, the controller 17 outputs a channel control signal so as to set the frequency of the selected channel in the tuner 11 (#61). The controller 17 then determines whether or not the selected channel is registered in the use antenna information table 100. If not registered (NO in #62), the process goes to a no signal process. On the other hand, if the selected channel is registered in the use antenna information table 100 (YES in #62), the controller 17 determines whether or not Yagi antenna-use information 100b is registered in the use antenna information table 100 so as to determine whether or not the antenna to be used to receive a TV broadcast signal of the selected channel is the smart antenna S (#63).

If Yagi antenna-use information 100b is not registered in the use antenna information table 100 for the selected channel (YES in #63), the controller 17 controls the RF switch 10 to make active the connection between the RF switch 10 and the smart antenna S (#64), and sets the best receiving direction 100c in the smart antenna S (#65), and further commands the MPEG decoder 13 to decode the received TV broadcast signal (#66). On the other hand, if the Yagi antenna-use information 100b is registered in the use antenna information table 100 for the selected channel (NO in #63), the controller 17 controls the RF switch 10 to make active the connection between the RF switch 10 and the Yagi antenna Y (#68), and commands the MPEG decoder 13 to decode the received TV broadcast signal (#66). If the decoding of the received TV broadcast signal is successful (YES in #67), the process goes to a video reception process, while if the decoding is unsuccessful (NO in #67), the process goes to a no signal process.

Referring now to FIG. 8, which shows a video reception process, the controller 17 commands the MPEG decoder 13 to decode the received TV broadcast signal (#81) into a video signal, which is output to the monitor 3, and to repeat the decoding if the decoding is successful (YES in #82). If the decoding is unsuccessful (NO in #82), the process goes to a no signal process.

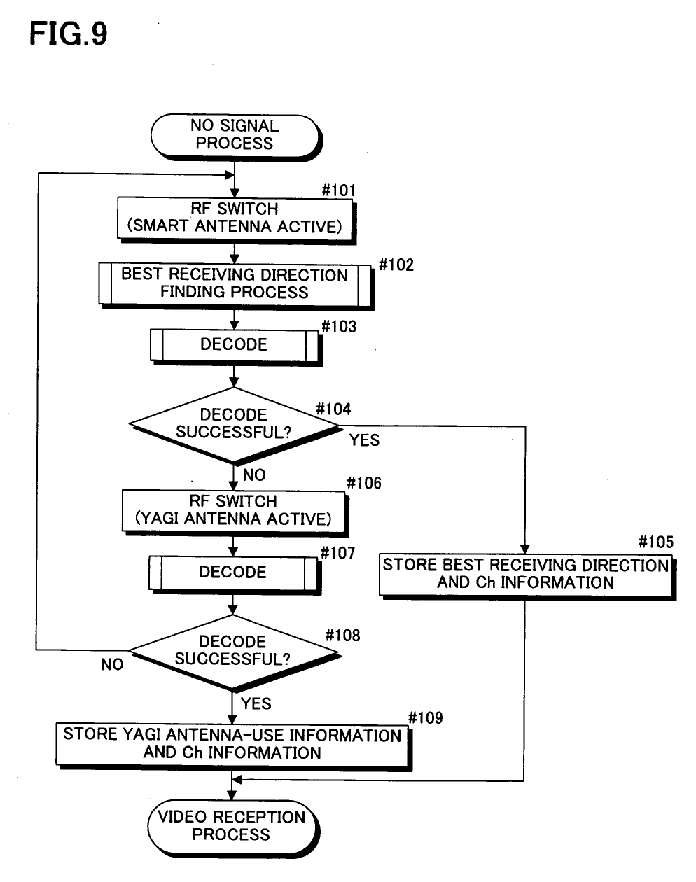

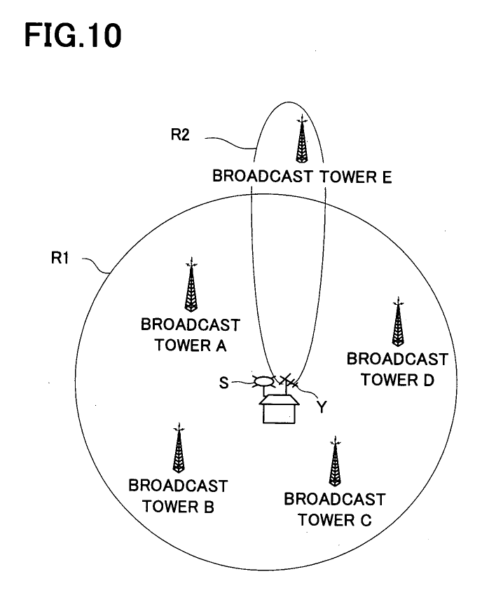

Referring next to the flow chart of FIG. 9, a no signal process will be described. When the no signal process is started, the controller 17 controls the RF switch 10 to make active the connection between the RF switch 10 and the smart antenna S (#101), and performs the above-described best receiving direction finding process so as to set the receiving direction of the smart antenna S to the best receiving direction 100c (#102), and further commands the MPEG decoder 13 to decode the received TV broadcast signal (#103). If the decoding is successful (YES in #104), the controller 17 stores the best receiving direction 100c for the selected channel in the memory 15 by associating the best receiving direction 100c with the channel number 100a (value of Ch) of the selected channel (#105), then going to the above-described video reception process.

On the other hand, if the decoding is unsuccessful (NO in #104), the controller 17 controls the RF switch 10 to make active the connection between the RF switch 10 and the Yagi antenna Y (#106), and commands the MPEG decoder 13 to decode the received TV broadcast signal (#107). If the decoding with the Yagi antenna Y is successful (YES in #108), the controller 17 stores the Yagi antenna-use information 100b for the selected channel in the memory 15 by associating the Yagi antenna-use information 100b with the channel number 100a (value of Ch) of the selected channel (#109), then going to the above-described video reception process. If, on the other hand, the decoding is unsuccessful with both the smart antenna S and the Yagi antenna Y (NO in #104 and NO in #108), the controller 17 repeats the steps from the step #101 to the step #108, continuing the no signal process.

As described in the foregoing, the TV broadcast receiver 1 according to the present embodiment determines the better or best one of the smart antenna S and the Yagi antenna Y for each channel on the basis of receiving conditions (more specifically on the basis of BER values) of TV broadcast signals using the two antennas S and Y so as to determine use antenna information (use antenna information table 100), based on which one of the two antennas S and Y to be used to receive a TV broadcast signal of each channel is to be determined, and based on which a best receiving direction is to be determined in the case of using the smart antenna S. Thus, on the basis of the use antenna information (use antenna information table 100), one of the antennas S and Y to be used to receive the TV broadcast signal for each channel is determined, so as to control the RF switch 10 to switch to the connection between the tuner 11 and the determined one of the antennas S and Y Thus, when selecting and receiving each channel, the TV broadcast receiver 1 makes it possible to select the better or best one of the antennas S and Y for the each channel. Furthermore, when receiving a TV broadcast signal using the smart antenna S, the TV broadcast signal can be received under a best receiving condition, because a best receiving direction among the multiple receiving directions of the smart antenna S can be found for each channel by the best receiving direction finding process.

In addition, the TV broadcast receiver 1 has the memory 15 for storing the use antenna information (use antenna information table 100) containing the best receiving directions 100c and/or the Yagi antenna-use information 100b, so that as to channels for which the best receiving directions 100c and/or the Yagi antenna-use information 100b are stored in the memory 15, it is not required for the TV broadcast receiver 1 to determine the best receiving direction 100c or the use of the Yagi antenna Y again at the time of selecting one of the channels and receiving a TV broadcast signal of the selected channel. At such time, the TV broadcast receiver 1 makes it possible to immediately receive a TV broadcast signal of the selected channel by using the better or best one of the smart antenna S and the Yagi antenna Y, and using the best receiving direction in the case of using the smart antenna S.

It is to be noted that the present invention is not limited to the above embodiments, and various modifications are possible. For example, in place of the BER values of received TV broadcast signals, signal intensities of the received TV broadcast signals can be used to determine receiving conditions of the received TV broadcast signals. In such case, the TV broadcast signals can be not only digital signals, but also analog signals.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

1. A television broadcast receiver connected to a unidirectional antenna having a single receiving direction and to a multi-directional antenna having multiple receiving directions, the television broadcast receiver comprising: a tuner for selecting a desired channel of television broadcast signals received by either the unidirectional antenna or the multi-directional antenna; a reception control unit for outputting, to the tuner, a channel control signal to command a channel to be selected, and/or for outputting, to the multi-directional antenna, a receiving direction control signal to command a receiving direction for receiving a television broadcast signal, so as to control a reception process of receiving the television broadcast signal; an antenna connection switching unit connected between the tuner and each of the unidirectional antenna and the multi-directional antenna for alternatively making active either the connection of the unidirectional antenna with the tuner or the connection of the multi-directional antennal with the tuner; a first receiving condition determination unit for controlling the antenna connection switching unit to make active the connection of the unidirectional antenna with the tuner, and for determining receiving condition of receiving a television broadcast signal with the unidirectional antenna for the channel selected by the tuner; a second receiving condition determination unit for controlling the antenna connection switching unit to make active the connection of the multi-directional antenna with the tuner, and for determining receiving condition of receiving a television broadcast signal with the multi-directional antenna for the channel selected by the tuner; and a use antenna information determination unit for determining either the unidirectional antenna or the multi-directional antenna as a best antenna for each channel, using the first receiving condition determination unit and the second receiving condition determination unit, and for determining use antenna information, based on which either the unidirectional antenna or the multi-directional antenna to be used for each channel is to be determined, wherein based on the use antenna information, the reception control unit determines either the unidirectional antenna or the multi-directional antenna to be used when receiving a television broadcast signal for each channel, and controls the antenna connection switching unit to make active the connection of the tuner with the determined one of the unidirectional antenna and the multi-directional antenna to be used, and further outputs the channel control signal and/or the receiving direction control signal so as to control the reception process of receiving the television broadcast signal.

2. The television broadcast receiver according to claim 1, which further comprises a use antenna information storage unit for storing the use antenna information determined by the use antenna information determination unit.

3. A television broadcast receiver connected to a unidirectional antenna having a single receiving direction and to a multi-directional antenna having multiple receiving directions, the television broadcast receiver comprising: a tuner for selecting a desired channel of television broadcast signals received by either the unidirectional antenna or the multi-directional antenna; a reception control unit for outputting, to the tuner, a channel control signal to command a channel to be selected, and/or for outputting, to the multi-directional antenna, a receiving direction control signal to command a receiving direction for receiving a television broadcast signal, so as to control a reception process of receiving the television broadcast signal; a best receiving direction finding unit for finding a best receiving direction for each channel selected by the tuner from the multiple receiving directions of the multi-directional antenna when receiving a television broadcast signal with the multi-directional antenna for the each channel; an antenna connection switching unit connected between the tuner and each of the unidirectional antenna and the multi-directional antenna for alternatively making active either the connection of the unidirectional antenna with the tuner or the connection of the multi-directional antennal with the tuner; a first receiving condition determination unit for controlling the antenna connection switching unit to make active the connection of the unidirectional antenna with the tuner, and for determining receiving condition of receiving a television broadcast signal, with the unidirectional antenna for the channel selected by the tuner, on the basis of BER values of the received television broadcast signal, a second receiving condition determination unit for controlling the antenna connection switching unit to make active the connection of the multi-directional antenna with the tuner, and for determining receiving condition of receiving a television broadcast signal, in a best receiving direction with the multi-directional antenna for the channel selected by the tuner, on the basis of BER values of the received television broadcast signal, a use antenna information determination unit for determining either the unidirectional antenna or the multi-directional antenna to give the lower BER value for each channel, using the first receiving condition determination unit and the second receiving condition determination unit, and for determining use antenna information, based on which either the unidirectional antenna or the multi-directional antenna to be used for each channel is to be determined; and a use antenna information storage unit for storing the use antenna information determined by the use antenna information determination unit, wherein based on the use antenna information, the reception control unit determines either the unidirectional antenna or the multi-directional antenna to be used when receiving a television broadcast signal for each channel, and controls the antenna connection switching unit to make active the connection of the tuner with the determined one of the unidirectional antenna and the multi-directional antenna to be used, and further outputs the channel control signal and/or the receiving direction control signal so as to control the reception process of receiving the television broadcast signal.
